(19) United States
(12) Patent Application Publication
(10) Pub. No.: US 2015/0124948 A1
(43) Pub. Date: May 7, 2015

(54) METHOD AND APPARATUS FOR MANAGING LOW POWER MODE IN XDSL SYSTEMS

(71) Applicant: IKANOS COMMUNICATIONS, INC., Fremont, CA (US)

(72) Inventors: Avadhani SHRIDHAR, Santa Clara, CA (US); Massimo SORBARA, Freehold, NJ (US)

(21) Appl. No.: 14/532,651

(22) Filed: Nov. 4, 2014

Related U.S. Application Data
(60) Provisional application No. 61/899,706, filed on Nov. 4, 2013.

(51) Int. Cl. H04M 11/06; H04L 5/14; H04L 5/00

(52) U.S. Cl. CPC H04M 11/062; H04L 5/0055; H04L 5/1438
USPC 379/93.08

(57) ABSTRACT

According to certain aspects, the present invention provides methods and apparatuses for managing a low power mode in xDSL systems, and more particularly directed to a L2 mode exit procedure for VDSL systems that is robust and quick. In embodiments, parameters for exiting a low power mode are communicated between upstream and downstream modems before the low power mode is entered. According to certain aspects, these parameters include configurations for incrementally exiting low power mode in a plurality of stages. Embodiments of the invention include quickly estimating SNR at one or more stages of this plurality of stages. Additional or alternative embodiments include reliably signaling the beginning of low power mode exit. According to certain aspects, such signaling can include a synchro sequence of inverted and normal sync symbols.

### CROSS REFERENCE TO RELATED APPLICATIONS

The present application claims the benefit under 35 USC 119(e) of prior co-pending U.S. Provisional Patent Application No. 61/899,706, filed Nov. 4, 2013, the contents of which are hereby incorporated by reference in their entirety.

### FIELD OF THE INVENTION

The present invention relates generally to data communications, and in particular to methods and apparatuses for performing a low power mode exit procedure in xDSL systems.

### BACKGROUND OF THE INVENTION

In some conventional systems, modems transmit continuously at the same full power mode (known as L0 mode in VDSL systems for example) even when there is no user data to be transmitted over the DSL link. It is thus desirable to have a mode (known as L2 mode) that reduces power consumption of the modem when there is no or very little user data to be transmitted over the DSL link. The effects of entering L2 mode on system performance, such as crosstalk cancellation, are typically not problematic. However, when one or more lines are exiting L2 mode and resuming full power transmit levels associated with L0 mode, problems impacting system performance can arise.

Accordingly, there is a need for procedures for exiting the L2 mode and returning to the L0 mode quickly and effectively.

### SUMMARY OF THE INVENTION

According to certain aspects, the present invention provides methods and apparatuses for managing a low power mode in xDSL systems, and more particularly directed to a L2 mode exit procedure for VDSL systems that is robust and quick. In embodiments, parameters for exiting a low power mode are communicated between upstream and downstream modems before the low power mode is entered. According to certain aspects, these parameters include configurations for incrementally exiting low power mode in a plurality of stages. Embodiments of the invention include quickly estimating SNR at one or more stages of this plurality of stages. Additional or alternative embodiments include reliably signaling the beginning of low power mode exit. According to certain aspects, such signaling can include a synchro sequence of inverted and normal sync symbols.

In accordance with these and other aspects, a method according to embodiments of the invention includes managing a low power mode for a transmitting modem in an xDSL system, the managing including, before the transmitting modem enters the low power mode, configuring the transmitting modem with parameters for exiting the low power mode.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of a system that can implement a low power mode exit procedure according to embodiments of the invention;

FIG. 2 is a flowchart illustrating an example method of managing a low power mode according to embodiments of the invention; and

FIG. 3 is a timing diagram illustrating an example method of signaling the beginning of a low power exit according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Notably, embodiments of the invention will be described in connection with a useful example for the case of VDSL modems and communication systems. However, the invention is not limited to VDSL and is applicable to other xDSL modems and systems such as for example ADSL, or G.fast (the term “xDSL” referring to these and other digital subscriber line standards and systems).

According to certain aspects, the present inventors recognize that there are several known methods to reduce power consumption of the modem in L2 mode, such as reducing the transmit PSD level by a certain level over the entire spectrum while changing the bit loading, reducing the spectrum (i.e. reducing the number of tones) being transmitted, and discontinuous transmission where the transmitter is alternately shut off for a duration of time and then resumed for another duration of time (e.g. transmitting only a few data symbols per frame). A combination of one or more of these methods can be used to reduce the power consumption of the modem while maintaining the DSL link at a reduced data rate.

Regardless of the power reduction method used, determining when a given DSL link should exit L2 mode and switch back to L0 mode can be based on factors such as: an increase in data traffic that exceeds a specified threshold for a specified duration of time, indicating a higher data rate is required over the DSL link; a pre-configured time when to switch back to L0 mode, such as at times when usage is expected to increase; and a request from the other side modem.

According to certain additional aspects, the present inventors recognize that to exit from the low power, low data rate L2 mode back to the normal high data rate L0 mode, a procedure should be followed by the modems on both ends to exchange information and co-ordinate the transition in a seamless way without dropping traffic. The L2 mode exit procedure should be very quick to avoid very large buffers for the excess data traffic and to avoid large latency in delivering that network traffic. The L2 mode exit procedure should also be very robust as failure here will delay switching back to L0 mode, and since the L2 mode is transmitting at low power on reduced tones, it is more susceptible to noise.

Embodiments of the invention, therefore, are directed to methods and apparatuses that provide robustness, while maintaining quickness, in the L2 exit procedure.

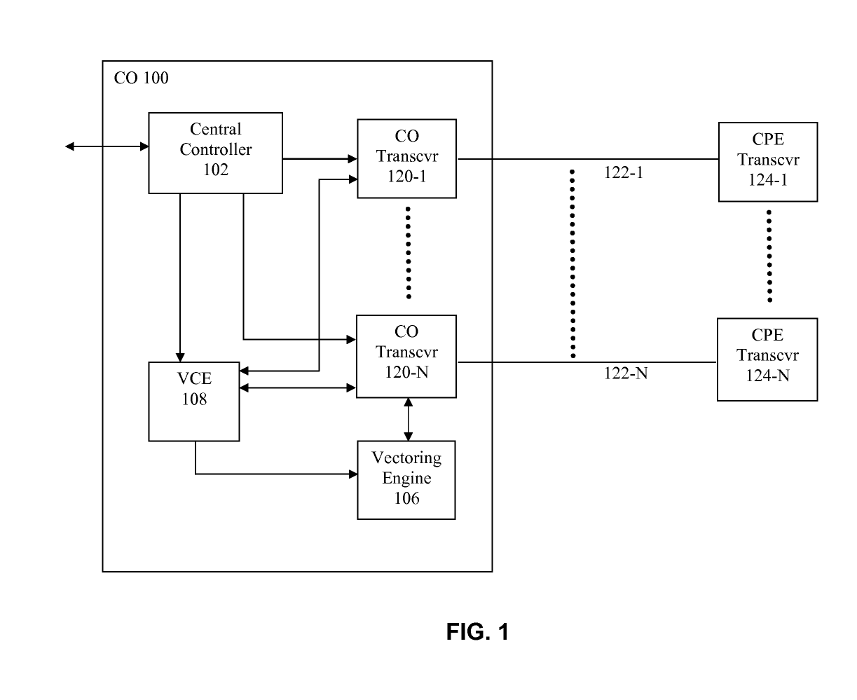

A block diagram illustrating an example xDSL system including a CO 100 for implementing aspects of the present invention is shown in FIG. 1. As shown, the example system includes central controller 102, vectoring engine 106, vectoring controller (VCE) 108 and CO transceivers 120-1 to 120-N. Transceivers 120-1 to 120-N are respectively coupled to downstream (i.e. CPE) transceivers 124-1 to 124-N via lines 122-1 to 122-N.

Some or all of lines 122-1 to 122-N may be included in the same bundle and/or may belong to a common vectoring group. As is known, vectoring (i.e. cancellation of cross-talk) of such lines 122 according to VDSL and other standards is handled by vectoring engine 106 using crosstalk (e.g. FEXT) coefficients programmed into vectoring engine 106 by VCE 108. These coefficients can be based on channel characteristics learned from transceivers 120 during a learning phase by VCE 108. The VCE 108 controls the training stages of the transceivers 120 to ensure that the transceivers go through their training stages in a co-ordinated manner without causing excessive interference to the lines that are already trained and operating in Showtime. Depending on the number of active ones of lines 122 at any given time, and perhaps further dependent on the cross-talk seen, the target data rates and tones used by such active lines, VCE 108 can adjust the coefficients used by vectoring engine 106. The central controller 102 is the overall controller of the xDSL system, configures the CO transceivers 120 and the VCE 108, monitors status and reports to a network management system.

Central controller 102, vectoring engine 106 and VCE 108 can be implemented by processors, chipsets, firmware, software, etc. such as Velocity-3 NodeScale Vectoring products provided by Ikanos Communications, Inc. It should be noted that, although shown separately for ease of illustration, some or all of components 102, 106, 108 and 120 may be incorporated into the same chips or chipsets. For example, in the Ikanos Velocity-3 NodeScale Vectoring products, the VCE 108 and the vectoring engine 106 are incorporated in one chip and 16 of the CO transceivers 120 are incorporated in a multi-port transceiver chip. Those skilled in the art will be able to understand how to adapt these and other similar commercially available products for use with the present invention after being taught by the present examples.

Meanwhile, CO transceivers 120 and CPE transceivers 124 include conventional processors, chipsets, firmware, software, etc. that implement communication services such as those defined by VDSL2, for example. Those skilled in the art will be able to understand how to adapt such products for use with the present invention after being taught by these examples.

According to embodiments of the invention, in operation of a system such as that shown in FIG. 1, some or all of lines 122 (i.e. DSL links) can be operated in both normal power (i.e. L0O mode and low power (i.e. L2) mode, in either or both of the downstream (i.e. CO to CPE) and upstream (i.e. CPE to CO) directions.

In some embodiments, central controller 102 determines which lines 122 enter and exit L2 mode, and communicates with transceivers 120 and/or 124 to configure the parameters for when and how L2 mode is entered/exited for these lines. In such embodiments, central controller 102 can configure each of lines 122 separately, or groups of lines 122 can be configured in a substantially similar way. When changing modes between L0 and L2, central controller 102 can communicate with VCE 108 so that the vectoring coefficients used by vectoring engine 108 can be updated. For example, in L2 mode, a line may transmit only a small portion of the time (such as 4 symbols every 256 symbols, etc). In some cases, when a line is not transmitting, the VCE may need to update the canceller coefficients for the remaining lines. In some other cases, the VCE may simply tell the vectoring engine to not cancel the data from the transceiver that is not transmitting in a symbol. Hence, it is needed in some cases for the central controller or VCE to determine which lines 122 enter L2 mode and when.

In other embodiments, some or all of transceivers 120 and/or 124 can determine for themselves when and how to enter and exit L2 mode. This can be done asynchronously based on factors such as those described above, on the availability of network data for a transceiver, or on demand from transceivers on the other end, or according to some pre-configured schedule. For example, in a non-vectored environment, a CO transceiver that is not getting any network data for a port for a period of time can decide to put that port in L2 mode to save power. Moreover, it is possible for transceivers on one end of line 122, for example CO transceivers 120, to control L2 exit mode parameters for both downstream and upstream communications.

It should be noted that combinations of these embodiments are possible. For example, central controller 122 can configure certain of transceivers 124 with a pre-defined schedule for entering and exiting L2 mode as well as associated exit parameters such as those described in more detail below, and thereafter transceivers 124 can independently enter and exit L2 mode on their own according to the pre-defined schedule.

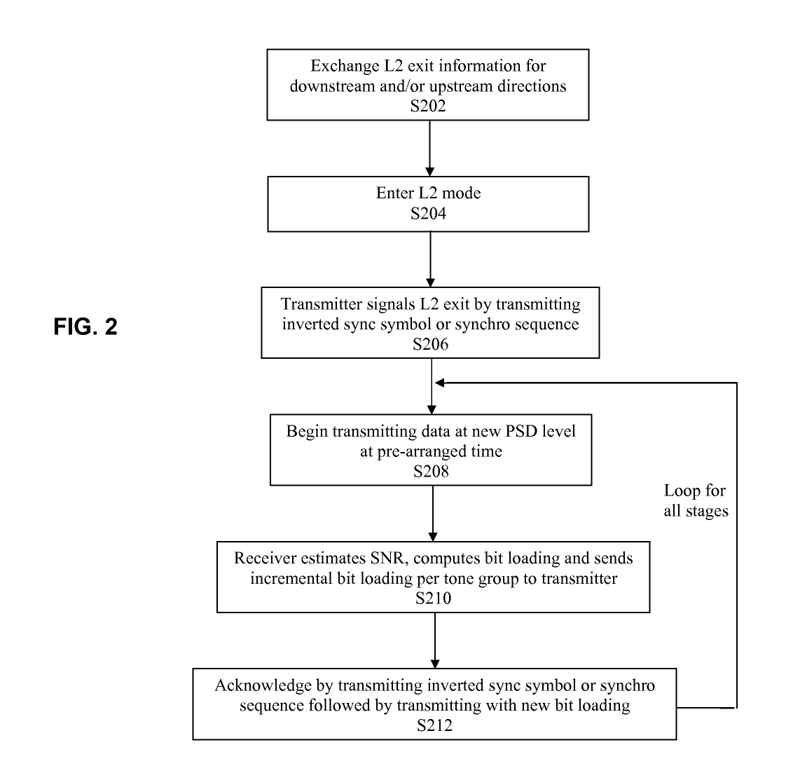

An example L2 mode exit procedure according to embodiments of the invention will now be described in connection with the flowchart in FIG. 2. Although this procedure will be described in connection with an example embodiment where it is controlled by a CO transceiver 120, those skilled in the art will understand how to implement the invention in other embodiments, such as where central controller 122 and/or CPE transceiver 124 is involved, as set forth above.

As shown in step S202, in embodiments of the invention, the exchange of some or all of the information required for exiting L2 mode, is done prior to entering L2 mode, i.e., while in L0 mode itself. This reduces the time to exchange information during the L2 exit. The information that can be sent prior to entering L2 mode in embodiments of the invention can include the following L2 mode exit parameters.

A first parameter is the number of stages of increasing transmit PSD levels. The L2 transmit PSD can be raised to L0 transmit PSD level as a single change, in order to do the change quickly. However, this results in a large change in cross-talk levels. If the lines in the bundle are controlled by a vector canceller entity (e.g. VCE 108), the vector canceller can adjust for the large change in cross-talk levels. It is sometimes desirable, especially when there is no vector canceller or direct communication with a VCE, to increase the transmit PSD in several stages, with a smaller increase in transmit PSD at each stage. As used herein, the term N_stages represents the number of stages of transmit PSD increase.

A next parameter is the amount of change in transmit PSD at each stage of transmit PSD increase. The transmitted frequency spectrum can be broken into several bands, and the PSD change can be specified as an increase in dBm/Hz for each band, for example. A frequency band is typically represented by a starting tone and number of tones. These tones can be include entire sub-bands such as DS0 defined for VDSL2, or they can include only discrete subsets of tones in such sub-bands. The PSD change should be specified for each stage of the N_stages.

A next parameter is the duration of each stage of transmit PSD increase. The duration of each of these PSD level stages transmitted can be specified in terms of number of symbols, for example.

As set forth above, in embodiments, the number of stages of transmit PSD increases and the change in transmit PSD at each stage, is determined and controlled by the transmitting transceiver alone. In other embodiments, such parameters are controlled by central controller 102 which has knowledge of the entire network and how the cross-talk change is to be managed.

In either of these embodiments, the CO transceiver 120, while in L0 mode, sends a set of one or more messages to its corresponding CPE transceiver 124, containing the information about number of stages of PSD increases and the change in transmit PSD at each stage, for the downstream direction. CPE transceiver 124 acknowledges the correct reception of the message. After this message, the CO and CPE transceivers are ready for entering L2 mode in the downstream direction. The messages containing the exit parameters can be sent using a conventional control channel such as an embedded operations channel (EOC).

In embodiments, for the upstream direction, the CO transceiver 120, while in L0 mode, sends another set of one or more messages to its corresponding CPE transceiver 124, containing the information about number of stages of PSD increases and the change in transmit PSD at each stage, for the upstream direction. After this message, the CO and CPE transceivers 120, 124 are ready for entering L2 mode in the upstream direction.

For the steps described below, for the downstream direction, the CO transceiver 120 is the transmitter and the CPE transceiver 124 is the receiver. And for the upstream direction, the CPE transceiver 124 is the transmitter and the CO transceiver 120 is the receiver.

In step S204, L2 mode is entered. This can be done in a conventional manner, and signaled by the transmitter to the receiver using a conventional embedded operations channel (EOC), for example. According to aspects of the invention, however, L2 mode includes a reduction in transmit PSD levels to a certain minimum level to accommodate both a required minimum SNR level and a specified minimum data rate. This can also include changing the bit loading table in accordance with the lower data rate. Moreover, this can further include changing framing, for example based on changes to framing parameters such as Reed/Solomon parameters, interleaving depth, number of overhead bytes, etc.

As set forth previously, the decision to enter and exit L2 mode can be based on various factors. For example, there can be specified traffic thresholds, and when traffic falls below a certain low threshold for a specified duration of time, indicating a lower data rate is over the DSL link is sufficient, the L2 mode can be entered. Likewise, when traffic exceeds a certain high threshold for a specified duration of time, indicating a higher data rate is required over the DSL link, the L2 mode can be exited. As another example, there can be pre-configured times scheduled for both L0 and L2 modes, based on times when usage is expected to be high and low, respectively. As another example, entry and/or exit from the L2 mode can be initiated by a request from the other side modem.

In step S206, the transmitter signals the start of the exit out of L2 mode to the receiver. In embodiments, this is done through an inverted sync symbol in the position of a normal sync symbol. As is known, once the modem is in data transmission mode (“showtime”), the sync symbol is sent in DSL at a fixed position periodically (example: 256 data symbols followed by a sync symbol). The sync symbol has a pre-defined set of values on each tone. The inverted sync symbol is obtained by changing the signs of the real and imaginary values of each tone. By sending the inverted sync symbol at the known symbol position, rather than during a data symbol, the receiver can be sure that it is not mistakenly identifying a data symbol as an inverted sync symbol.

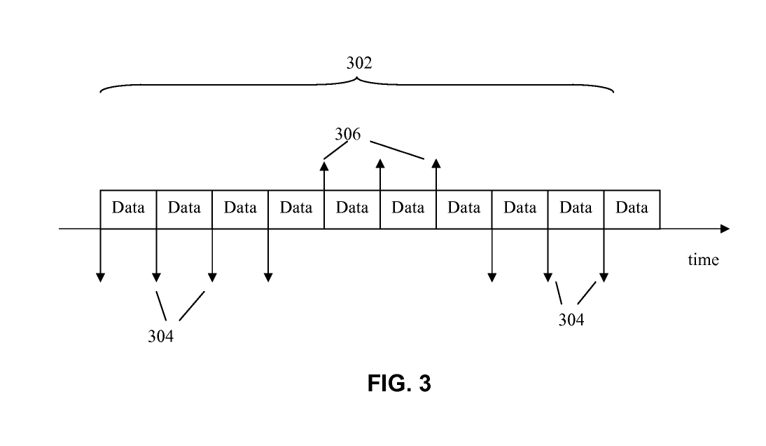

In other embodiments, such as that illustrated in FIG. 3, the transition can be made more robust by a “synchro” sequence 302 of inverted sync symbols 304 and normal sync symbols 306. For example, the first inverted sync symbol 304 at the position of normal sync symbol could be followed by a sequence of three inverted sync symbols 304 at the next three sync symbol positions, then three normal sync symbols 306, and then three inverted sync symbols 304. This sequence 302 of ten sync or inverted sync symbols, increases robustness in case one or more of the symbols gets corrupted by noise.

The N symbols in the L2 exit synchro sequence of inverted or normal sync symbols are transmitted at the existing (L2 mode) PSD level. The L2 exit synchro symbols allow the receiver (i.e. VTU-R) to reliably detect and do any adjustment of its receiver parameters.

In step S208, after the last of the L2 exit synchro symbols, the transmitter starts transmitting data symbols at the first increased PSD level that was specified in the parameters sent in step S202, while continuing with the existing L2 bit loading and framing. Tones with zero bit loading that now have non-zero power levels due to the PSD increase have known PRBS values modulated on them, known as monitor tones, for example.

In step S210, the receiver estimates the SNR and computes the new bit loading parameters, and sends a request to the transmitter with a message indicating the change in bit loading for each group of tones.

According to embodiments, to keep the exit procedure quick, the SNR can be estimated by the receiver for a short duration to get an approximate estimate of the SNR. For example, SNR averaging could be done in a conventional manner but over 100 to 400 symbols, instead of the typical 1000 to 4000 symbols. Conservatively, some extra margin can be applied while using this short duration SNR estimate to do the bit loading. Those skilled in the art will be able to understand how to calculate such bit loading for a given SNR estimate, and so further details thereof will be omitted here for the sake of clarity of the invention.

The exchange of the new bit loading from the receiver to the transmitter can be sped up by sending the incremental bit loading per group of tones. The group of tones could be the same set of group of tones used in the PSD increase specification described above, or it could be a different set of groups of tones. Since the PSD will be increased by a fixed amount over a group of tones, it is very likely that the increase in bit loading will be same over the group of tones, and hence this is a very efficient way of encoding the bit table. For a group of tones with group number ‘k’, the message specifies a change in bit loading delta_k. For each tone ‘t’ in the group number ‘k’, if delta_k is positive, its bit loading is changed to Max(bₜ+delta_k, Max_bit_loading), where bₜ is the current bit loading of tone T, and Max_bit_loading is the maximum bit loading allowed in the system. In addition, if the L2 mode used a set of tones that continued to transmit at full power, then those tones can be optionally excluded from this incremental bit loading. When changing the mode from L2 mode to L0 mode, the data rate is typically increased, and the bit loading in a tone group is typically increased or kept unchanged. If, while increasing some tone group's bt loading, it is required to reduce some tone group's bit loading, delta_k can be a negative number to reduce a group's bit loading. If delta_k is negative for a tone group numbered ‘k’, each tone in that group number ‘k’, its bit loading is changed to Min(bₜ+delta_k, Min_bit_loading), where Min_bit_loading is the minimum bit loading on a tone, which is usually zero.

In step S212, the transmitter acknowledges the changes through an inverted sync symbol instead of a normal sync symbol. Similar to the sequence shown in FIG. 3, the next N symbols form a L2 exit synchro transmitted at the existing (L0 mode) PSD level. The L2 exit synchro symbols allow the receiver to reliably detect the transition and then based on its request, adjust its receiver parameters accordingly. The receiving parameters that are adjusted can include bit loading on tones, receive path gains, frequency coefficients, framing parameters, etc. After the last of the L2 exit synchro symbol, the transmitter starts transmitting data symbols at the existing (L0 mode) PSD level with the new bit loading that was requested by the receiver in step 4. After this step, the modems have now transitioned to L0 mode.

As shown in FIG. 2, if multiple PSD transition stages (i.e. N_stages>1) were specified in the messaging, then the transmitter loops back to step S208 and proceeds to do these further PSD transitions after the specified number of symbols until all N_stages have been completed.

Once in L0 mode, the receiver can do further increases in data rate either through a quick SNR measurement followed by a request to a bit loading increase per group of tones, or through a regular L0 mode Seamless Rate Adaptation (which is typically done with a long, more accurate SNR measurement followed by a long message with request for bit loading on a per tone basis).

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method comprising:
managing a low power mode for a transmitting modem in an xDSL system, the managing including, before the transmitting modem enters the low power mode, configuring the transmitting modem with parameters for exiting the low power mode.

2. A method according to claim 1, wherein the xDSL system is VDSL.

3. A method according to claim 1, wherein configuring includes communicating the parameters between the transmitting modem and a corresponding receiving modem in the xDSL system.

4. A method according to claim 1, wherein the parameters include configurations for incrementally exiting the low power mode by increasing transmit power levels in a plurality of stages.

5. A method according to claim 3, wherein the parameters include configurations for incrementally exiting the low power mode by increasing transmit power levels in a plurality of stages.

6. A method according to claim 5, wherein managing further includes causing the receiving modem to quickly estimate SNR at one or more stages of the plurality of stages.

7. A method according to claim 5, wherein managing further includes causing the receiving modem to calculate a bit loading at one or more stages of the plurality of stages.

8. A method according to claim 7, wherein managing further includes causing the receiving modem to transmit the calculated bit loading to the transmitting modem.

9. A method according to claim 8, wherein managing further includes causing the transmitting modem to reliably acknowledge receipt of the transmitted bit loading to the receiving modem.

10. A method according to claim 1, wherein the parameters include configurations for incrementally exiting the low power mode by increasing data throughput levels in a plurality of stages.

11. A method according to claim 3, wherein the parameters include configurations for incrementally exiting the low power mode by increasing data throughput levels in a plurality of stages.

12. A method according to claim 1, wherein managing includes causing the transmitting modem to reliably signal the beginning of exiting the low power mode.

13. A method according to claim 12, wherein the signaling includes a synchro sequence of inverted and normal sync symbols at expected sync symbol positions defined by the xDSL system.

14. A method according to claim 4, wherein the parameters include configurations for a change in transmit PSD at each of the plurality of stages.

15. A method according to claim 14, wherein the change is specified for a plurality of bands of contiguous tones in a transmit spectrum.

16. A method according to claim 4, wherein the parameters include configurations for a duration of each of the plurality of stages.

17. A method according to claim 4, wherein the communicating is performed using an embedded operations channel (EOC).

18. An xDSL system comprising:
a central controller; and
a transmitting modem,
wherein the central controller manages a low power mode for the transmitting modem by, before the transmitting modem enters the low power mode, configuring the transmitting modem with parameters for exiting the low power mode.

19. An xDSL system according to claim 18, further comprising
a receiving modem,
wherein before the transmitting modem enters the low power mode, the parameters are communicated between the transmitting modem and the receiving modem.

20. An xDSL system according to claim 18, wherein the parameters include configurations for incrementally exiting the low power mode by increasing transmit power levels in a plurality of stages.
